(19) United States
(12) Patent Application Publication
(10) Pub. No.: US 2025/0111323 A1
(43) Pub. Date: Apr. 3, 2025

(54) AUTOMATED QUALITY METRIC MODELS BASED ON CUSTOMER DATA

(71) Applicant: Verint Americas Inc., Alpharetta, GA (US)

(72) Inventors: Ron Peretz Epstein Koch, Alpharetta, GA (US); Karni Gilon, Alpharetta, GA (US); Dvir Cohen, Alpharetta, GA (US)

(21) Appl. No.: 18/477,701

(22) Filed: Sep. 29, 2023

(51) Int. Cl. G06Q 10/0639; G06N 3/045; G06N 3/08

(52) U.S. Cl. CPC G06Q 10/06395; G06N 3/045; G06N 3/08

(57) ABSTRACT

Systems and methods for automating quality metrics are provided. Transcripts of interactions with agents and assigned quality metrics for a variety of questions are collected for an entity. The quality metrics may relate to questions such as “Did the agent greet the customer with a friendly greeting?” and “Did the agent answer the customer's question after returning from the hold?”. For each question used by the entity to generate quality metrics, a large language model or classifier is trained for the question using the transcripts and the assigned quality metrics for the question. The transcripts may be processed to include textual information corresponding to metadata associated with the communications such as time stamps for call holds, utterances, and silent periods. The trained large language model or classifiers may then be used later to automatically assign quality metrics to current interactions for their corresponding question.

### BACKGROUND

Quality management involves monitoring customer/agent interactions in a contact center and—based on that monitoring—evaluating agent performance and behavior across a wide range of criteria. The monitoring and evaluation process is manual and labor intensive, hence only a small fraction of the interactions (1-3%) are sampled and evaluated.

This results in insights into agent performance based on a statistically invalid sample size, as well as a significant risk not detecting or detecting very late quality or compliance issues that happen infrequently and hence are not observed in the sampled calls. Moreover, because the evaluation outcome is also based on the individual evaluator's decision and hence is subjective, that leads to an additional effort from the organization side to calibrate their evaluators to make sure they evaluate the agents based on the same criteria and in a consistent manner.

Previous approaches to address the problems noted above are based on automating quality metrics by defining rules that look at specific key words and phrases that are present (or not present) in the interaction, along with interaction metadata, to automatically answer questions in an evaluation form based on these rules. This approach, however, has a significant drawback in that It requires a significant effort in identifying these key phrases, words and interaction metadata, and making sure that the rules (based on the above) correctly answer the questions in the evaluation form. As a result, there is a considerable time and effort that needs to be invested before the value of automating quality metrics can be realized.

### SUMMARY

Systems and methods for automating quality metrics are provided. Transcripts of interactions with agents and assigned quality metrics for a variety of questions are collected for an entity. The quality metrics may relate to questions such as “Did the agent greet the customer with a friendly greeting?” and “Did the agent answer the customer's question after returning from the hold?”. For each question used by the entity to generate quality metrics, a large language model or classifier is trained for the question using the transcripts and the assigned quality metrics for the question. The transcripts may be processed to include textual information corresponding to metadata associated with the communications such as time stamps for call holds, utterances, and silent periods. The trained large language model or classifiers may then be used later to automatically assign quality metrics to current interactions for their corresponding question.

In some aspects, the techniques described herein relate to a method for automating quality metrics including: receiving interaction data representing previous interactions with one or more agents by a computing device, wherein each interaction is associated with a question and a quality metric; using a first portion of the interaction data representing the previous interactions, training a first large language model by the computing device; receiving interaction data representing a current interaction by the computing device; generating a quality metric for the question for the current interaction using the first large language model and the interaction data representing the current interaction; and associating the quality metric for the question with the current interaction.

In some aspects, the techniques described herein relate to a method, wherein the interaction data for a previous interaction includes a call transcript.

In some aspects, the techniques described herein relate to a method, wherein the interaction data for a previous interaction includes a call transcript and metadata, and further including: mapping the metadata to text; and adding the text to the call transcript. The interaction data may further include comments explaining a score given to the previous interaction and/or specific phrases from the previous interaction.

In some aspects, the techniques described herein relate to a method, further including: training a classifier using the first portion of the interaction data representing the previous interactions; using a second portion of the interaction data representing the previous interactions, generating performance indicators for the classifier and the first large language model; and generating the quality metric for the question for the current interaction using one of the first large language model or the classifier based on the performance indicators. The classifier may also be trained on the same portion of the interaction data as the LLM depending on whether LLM embedding used an out of the box LLM or a fine-tuned LLM. Other methods for training the classifier may include prompt tuning, few-shot tuning, fine tuning, and training using LLM embeddings.

In some aspects, the techniques described herein relate to a method, further including: using the second portion of the interaction data, generating performance indicators for a second large language model, wherein the second large language model is not trained using the interaction data; and generating the quality metric for the question for the current interaction using one of the first large language model, the second large language model, or the classifier based on the performance indicators.

In some aspects, the techniques described herein relate to a method, further including: determining that the generated performance indicators for the first large language model, the second large language model, and the classifier all fall below a threshold; and in response to the determination, generating the quality metric for the question for the current interaction using some combination of the first large language model, the second large language model, and the classifier based on the performance indicators.

In some aspects, the techniques described herein relate to a method, wherein the classifier includes a neural network classifier.

In some aspects, the techniques described herein relate to a system for automating quality metrics including: a computing device; and a computer-readable medium with computer-executable instructions stored thereon that when executed by the computing device cause the computing device to: receive interaction data representing previous interactions with one or more agents, wherein each interaction is associated with a question of a plurality of questions and a quality metric; using a first portion of the interaction data representing the previous interactions, train a first large language model; receive an evaluation including at least one question of the plurality of questions and interaction data representing a current interaction; generate a quality metric for the at least one question for the current interaction using the first large language model and the interaction data representing the current interaction; and associate the quality metric for the at least one question with the current interaction.

In some aspects, the techniques described herein relate to a system, wherein the interaction data for a previous interaction includes one or more of a call transcript, a chat, or an email.

In some aspects, the techniques described herein relate to a system, wherein the interaction data for a previous interaction includes a call transcript and metadata, and further including computer-executable instructions that when executed by the computing device cause the computing device to: map the metadata to text; and add the text to the call transcript.

In some aspects, the techniques described herein relate to a system, further including computer-executable instructions that when executed by the computing device cause the computing device to: train a classifier using the first portion of the interaction data representing the previous interactions; using a second portion of the interaction data representing the previous interactions, generate performance indicators for the classifier and the first large language model; and generate the quality metric for the question for the current interaction using one of the first large language model or the classifier based on the performance indicators.

In some aspects, the techniques described herein relate to a system, further including computer-executable instructions that when executed by the computing device cause the computing device to: use the second portion of the interaction data, generating performance indicators for a second large language model, wherein the second large language model is not trained using the interaction data; and generate the quality metric for the question for the current interaction using one of the first large language model, the second large language model, or the classifier based on the performance indicators.

In some aspects, the techniques described herein relate to a system, further including computer-executable instructions that when executed by the computing device cause the computing device to: determine that the generated performance indicators for the first large language model, the second large language model, and the classifier all fall below a threshold; and in response to the determination, generate the quality metric for the question for the current interaction using some combination of the first large language model, the second large language model, and the classifier based on the performance indicators.

In some aspects, the techniques described herein relate to a system, wherein the classifier includes a neural network classifier, XGBoost, or others.

In some aspects, the techniques described herein relate to a non-transitory computer-readable medium with computer-executable instructions stored thereon that when executed by a computing device cause the computing device to: receive interaction data representing previous interactions with one or more agents, wherein each interaction is associated with a question of a plurality of questions and a quality metric; using a first portion of the interaction data representing the previous interactions, train a first large language model; receive an evaluation including at least one question of the plurality of questions and interaction data representing a current interaction; generate a quality metric for the at least one question for the current interaction using the first large language model and the interaction data representing the current interaction; and associate the quality metric for the at least one question with the current interaction.

In some aspects, the techniques described herein relate to a computer-readable medium, wherein the interaction data for a previous interaction includes one or more of a call transcript, a chat, or an email.

In some aspects, the techniques described herein relate to a computer-readable medium, wherein the interaction data for a previous interaction includes a call transcript and metadata, and further including computer-executable instructions that when executed by the computing device cause the computing device to: map the metadata to text; and add the text to the call transcript.

In some aspects, the techniques described herein relate to a computer-readable medium, further including computer-executable instructions that when executed by the computing device cause the computing device to: train a classifier using the first portion of the interaction data representing the previous interactions; using a second portion of the interaction data representing the previous interactions, generate performance indicators for the classifier and the first large language model; and generate the quality metric for the question for the current interaction using one of the first large language model or the classifier based on the performance indicators.

In some aspects, the techniques described herein relate to a computer-readable medium, further including computer-executable instructions that when executed by the computing device cause the computing device to: use the second portion of the interaction data, generating performance indicators for a second large language model, wherein the second large language model is not trained using the interaction data; and generate the quality metric for the question for the current interaction using one of the first large language model, the second large language model, or the classifier based on the performance indicators.

In some aspects, the techniques described herein relate to a computer-readable medium, further including computer-executable instructions that when executed by the computing device cause the computing device to: determine that the generated performance indicators for the first large language model, the second large language model, and the classifier all fall below a threshold; and in response to the determination, generate the quality metric for the question for the current interaction using some combination of the first large language model, the second large language model, and the classifier based on the performance indicators.

The systems and methods described herein provide many advantages over the prior art. First, by training large language models and/or classifiers using an entity or organization's own historical transcripts and quality metrics to assign quality metrics to new communication transcripts, the time and effort required to complete quality metrics is greatly reduced. This allows quality metrics for a new communication to be generated and provided to an agent almost as soon as a communication is completed. Providing quality metrics quickly helps ensure that the agents are meeting expectations and allows agents to fully consider the quality metrics while the communication is fresh in mind. Second, performance indicators for each large language model and classifier are generated for each question of each evaluation, which ensures that the best performing large language model or classifier is selected to generate quality metrics for each question of an evaluation.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the disclosed embodiments, there is shown in the drawings example constructions of the embodiments; however, the possible embodiments are not limited to the specific methods and instrumentalities disclosed. In the drawings:

FIG. 1 illustrates an example environment for automating quality metrics;

FIG. 2 illustrates an example flow diagram of a method for training one or more models for questions based on historical interaction data;

FIG. 3 illustrates an example flow diagram of a method for selecting a model that has the highest performance indicators for a question;

FIG. 4 illustrates an example flow diagram of a method for automating quality metrics for an evaluation using one or more models; and

FIG. 5 is a schematic diagram of a computer system that may be utilized to implement forecasting algorithm selection in accordance with the disclosure according to certain embodiments.

### DETAILED DESCRIPTION

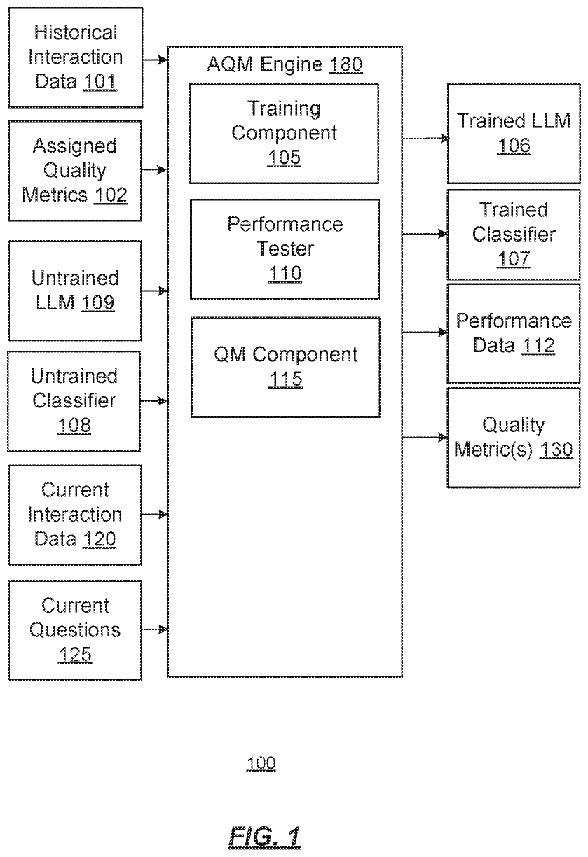

FIG. 1 is an illustration of an example environment 100 for performing automated quality metrics (AQM). Entities, such as call centers, typically assign quality metrics to agent interactions such as calls or chats. Generally, each quality metric is associated with a question meant to gauge whether or not an agent complied with one or more entity policies. Example questions for an agent interaction such as a telephone call may include “Did the Agent begin the call with a friendly greeting?”, “Did the Agent answer the questions asked by the customer during the call?”, and “Did the Agent correctly authenticate the customer?”, and “Did the Agent keep the customer on hold too long?” Other questions may be supported. The answers or scores assigned to the questions for an agent interaction are the quality metrics.

Entities may periodically evaluate their agents by generating quality metrics for a selection of agent interactions. As may be appreciated, such evaluations are extremely time consuming because human reviewers typically listen to a recording or transcript of each interaction and assign a quality metric to each question associated with the evaluation.

Accordingly, to help automate the process of agent evaluations and the generation of quality metrics, the environment 100 may include an AQM engine 180. The AQM engine 180 may receive current interaction data 120 for an interaction between an agent and a customer (e.g., a transcript of a call or chat), and may use one or more models to automatically generate quality metrics 130 for the interaction. Because the quality metrics 130 are generated automatically and without human review, every agent interaction can be evaluated, rather than a selected subset. In addition, because the AQM engine 180 can review agent interactions much faster than human reviewers, agent interactions may be reviewed and assigned quality metrics soon after they have been completed, which can be provided to the agents to provide immediate and relevant feedback while the associated interactions are still fresh in the minds of the agents.

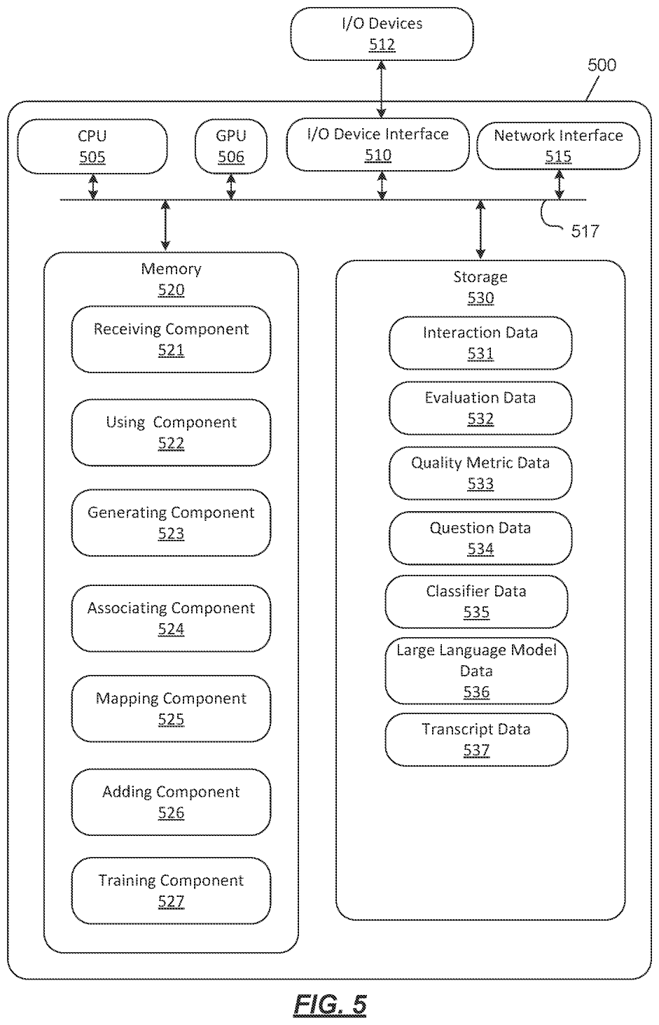

As shown, the AQM engine 180 includes several components, including, but not limited to, a training component 105, a performance tester 110, and a QM component 115. More or fewer components may be supported. The components of the AQM engine 180 may be implemented together or separately using one or more general purpose computing devices such as the computer 500 illustrated with respect to FIG. 5.

The training component 105 may train one or more models to generate quality metrics for questions using historical interaction data 101. The historical interaction data 101 may include interaction data for a plurality of interactions along with tags that represent the quality metrics assigned to each interaction for one or more questions. These tags are referred to the assigned quality metrics 102. The assigned quality metrics 102 of the historical interaction data 101 may be based on agent evaluations performed by one or more human evaluators for a variety of entities. The historical interaction data 101 may be received for a single entity or multiple entities.

The interaction data 101 for each interaction may include transcripts or recordings of each interaction as well as metadata about one or more events that occurred during the interaction. The events may include indications of times when the agent put the customer on hold, or sentiments detected during the interaction (e.g., was the customer angry or happy). Other events may be supported. Interactions as used herein may include telephone interactions, chat interactions, email or text-based interactions, and social media-based interactions. Other types of interactions may be supported. The historical interaction data 101 for an interaction may further include comments from an evaluator explaining the assigned quality metrics (and can also contain specific phrases from the interaction).

The AQM engine 180 may select a subset of the questions associated with the assigned quality metrics 102 and may use a portion of the historical interaction data 101 and assigned quality metrics 102 associated with the selected subset of questions to train one or more models. Depending on the embodiment, the training component 105 may be adapted to generate at least one model for each question in the subset of questions, or a single model may cover multiple questions. The model generated for a question may be adapted to receive interaction data associated with an interaction, and to output a quality metric 130 for the interaction.

Depending on the embodiment, the questions selected for the subset of questions from the historical interaction data 101 may be questions that appear with some threshold frequency in the historical interaction data 101. Alternatively, the selected questions may correspond to questions currently found in evaluations used by one or more entities.

In some embodiments, before selecting the questions from the historical interaction data 101, the training component 105 may perform some preprocessing on the questions. For example, the training component 105 may turn compound or nested questions into single answer questions. As another example, the training component 105 may combine similar questions that use different language or phrasing into single questions.

In some embodiments, the models generated by the training component 105 for a question may include a trained large language model 106. Suitable trained LLMs 106 include Bart, Flan_T5, and TOPP. Other models may be used. In addition, the models generated for a question may include one or more trained classifiers 107. Suitable trained classifiers 107 include neural networks, XGBoost, Random forest, and SVM. Other types of classifiers may be used. Note that in some embodiments, a single model may be trained by the training component 105 for multiple questions.

In some embodiments, before generating the models, the training component 105 may perform some preprocessing of the received historical interaction data 101. As described above, the interaction data associated with an interaction may include metadata describing the content of the call such as the length of the call, when the agent put the call on hold, and indications of a durations of silent periods in the call. In order to make the interaction data more suitable for processing by large language models, the training component 105 may insert the metadata into the transcript associated with the interaction data as text. For example, if the metadata indicates silent periods at certain points in the interaction, text such as “<silent period: duration in milliseconds>” may be inserted at a corresponding location in the transcript for each silent period. Alternatively, text representations of the metadata may simply be appended to end of each transcript. Any method may be used.

In some embodiments, the training component 105 may train a classifier 107 for a question using a portion of the interaction data 101 and LLM embedding. The LLM embedding may come from either the trained LLM 106 or the untrained LLM 109. Where the trained LLM 106 is used for the LLM embeddings, the trained classifier 107 may be trained using a different portion of the historical interaction data than will be used to train the classifier 107.

After generating the models for the selected subset of questions from the historical interaction data 101, the training component 105 may store each of the generated models in a database or model storage. Each stored model may be associated with the question(s) that it was trained to generate a quality metric 130 for.

The performance tester 110 may test the stored generated models for each question to determine which model (or combination of models) is the best performing model for the question. In some embodiments, the performance tester 110 may test each model using a portion of the historical interaction data 101, and associated assigned quality metrics 102, that was not used to train the model.

As part of the testing process, the performance tester 110 may, for each question associated with a stored model, generate key performance indicators for each model, and may identify the model or combination of models that provides the best combination of key performance indicators for the question. Example key performance indicators may include accuracy, precision, and recall, for example. The importance or weight associated with each key performance indicator may be set by a user or administrator.

In particular, the performance tester 110 may, for each question associated with a stored model, determine which of the trained LLM 106 or the trained classifier 107 have the best key performance indicators for the question using the historical interaction data 101 and associated assigned quality metrics 102 not used to train the LLM 106 and the classifier 107. Where there are multiple KPIs, there may be different model and question pairs associated with each different KPI.

In addition to the trained LLM 106 and trained classifier 107, in some embodiments, the performance tester 110 may also determine key performance indicators for the question using an untrained LLM 109 and an untrained classifier 108. An untrained LLM 109 may be a standard or default LLM that was previously trained using data other than the historical interaction data 101 specific to an entity or entities. Typically, an untrained LLM 109 may have been trained using only publicly available data. The untrained LLM 109 may also be referred to as a default LLM, standard LLM, or non-specialized LLM in that it has been pretrained on data other than the historical interaction data 101.

Similarly, an untrained classifier 108 may be a standard or default classifier that was previously trained using data other than the historical interaction data 101 specific to an entity or entities. Any untrained or generic LLM 109 or classifier 108 may be used. For each question associated with a stored model, the performance tester 110 may store an indicator of which of the trained LLM 106, trained classifier 107, untrained LLM 109, or untrained classifier 108 performed the best for the question (i.e., had the best key performance indicators). The key performance indicators generated for each model and question may be stored by the performance tester 110 as performance data 112. Note that for each question there may be more than one trained LLM 106, trained classifier 107, untrained LLM 109, or untrained classifier 108 that is associated with the question.

The QM component 115 may use the generated models and performance data 112 for each question to generate quality metrics 130 for a current interaction. In some embodiments, an entity such as a call center may provide current interaction data 120 for a recent or current interaction between an agent and a customer. The interaction may be a call, and the current interaction data 120 may be a transcript of the call, chat, or other communication media such as e-mail. The interaction is a current or recent interaction and is not one of the interactions represented by the historical interaction data 101.

The current interaction data 120 may be provided to the QM component 115 along with one or more current questions 125. The current questions 125 may be questions from an evaluation used by the entity and the questions that the entity would like to use to generate quality metrics 130 for the current interaction represented by the current interaction data 120.

For example, a call center may, as a matter of policy, generate quality metrics at the end of every agent interaction, or after some number of interactions have been completed. Accordingly, at the end of the interaction, the entity may generate a transcript of the interaction (i.e., current interaction data 120) and may provide the transcript to the QM component 115 along with indicators of the current questions 125 (e.g., evaluation) used by the entity.

The QM component 115, may, for each question in the current question 125, identify stored questions that match, or partially match, the questions of the current questions 125. The matching stored questions are questions that the training component 105 has already generated trained models (e.g., the trained LLM 106 and trained classifier 107). In some embodiments, where the current questions 125 are long or require multiple steps and/or parts, the QM component 115 may simplify or rewrite the questions into smaller questions, and may look for matches for the smaller or rewritten questions in the stored questions as described above.

The QM component 115 may, for each question of the current questions 125, determine which of the models to use for the question based on the performance data 112 associated with the matching stored question for each question of the current questions 125. For example, if the performance data 112 for a matching stored question indicates that the trained LLM 106 performs best for the matching stored question, the QM component 115 may determine to use the trained LLM 106 for the question from the current questions 125. Alternatively, if the performance data 112 for a matching stored question indicates that the untrained LLM 109 performs best for the matching stored question, the QM component 115 may determine to use the untrained LLM 109.

After selecting the best performing model for each question of the current questions 125, the QM component 115 may use the best performing models to generate quality metrics 130 corresponding to each question using the current interaction data 120. The QM component 115 may then send the generated quality metrics 130 for the current questions 125 to the entity that provided the current interaction data 120.

In some embodiments, the QM component 115 may perform some processing on the current interaction data 120 before processing by the selected models. Where the current interaction data 120 includes metadata and a text transcript, the QM component 115 may remove some or all of the metadata and may add the metadata as text to the text transcript. For example, the QM component 115 may add indications to the transcript corresponding to metadata such as time stamps of certain events or indications of the beginning and ending of silent periods or on-hold periods. In addition, where the associated transcript of the current interaction data 120 is too long, the QM component 115 may divide the text transcript into two or more transcripts. The QM component may then generate quality metrics 130 for each portion of the transcript.

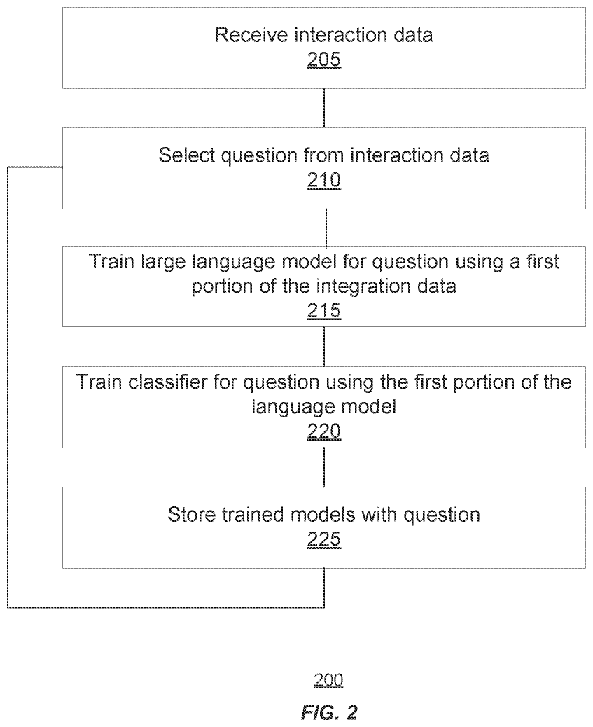

FIG. 2 illustrates an example flow diagram of a method 200 for training one or more models for questions based on historical interaction data. The method 200 may be implemented by one or more components of the AQM engine 180.

At block 205, interaction data is received. The interaction data may be historical interaction data 101 and may be received by the training component 105 of the AQM engine 180. The historical interaction data 101 may include data representing a plurality of past interactions between agents and customers for an entity such as a call center. The data representing an interaction may be a transcript of a telephone call or the text of a chat interaction.

Each interaction represented in the interaction data may be associated with a plurality of questions and an assigned quality metric 102 for each of the plurality of questions. The plurality of questions may have been part of an evaluation of the associated interaction and the assigned quality metrics 102 for each question may have been assigned by one or more human reviewers after reviewing the interaction.

At block 210, a question is selected from the plurality of questions associated with the interaction data. The question may be selected by the training component 105. In some embodiment, the question may be selected randomly or based on some ordering. Alternatively, the question may be a question that appears most frequently in the historical interaction data 101, meaning it was part of many evaluations. The question may further be selected because it appears in one or more current evaluations used by the entity or a different entity.

At block 215, a large language model is trained for the selected question using a first portion of the received interaction data. The trained LLM 106 may be trained by the training component 105. Any method for training an LLM may be used. Depending on the embodiment, multiple LLMs may be trained by the training component 105. Each trained LLM 106 may a different type of trained LLM 106.

At block 220, a classifier is trained for the selected question using the first portion of the received interaction data. The trained classifier 107 may be trained by the training component 105. Any method for training a classifier may be used. The trained classifier 107 may be a neural network, XGBoost, or others. Similar to the trained LLM 106, multiple types of trained classifiers 107 may be trained by the training component 105 using the first portion of the historical interaction data 101.

At block 225, the trained models are stored with the question. The models (the trained LLM 106 and the trained classifier 107) may be stored by the training component 105. After storing the models, the method 200 may return to the block 210 where any additional or remaining questions of the historical interaction data 101 may be selected to receive trained models. If no questions remain to be selected, the method 200 may exit.

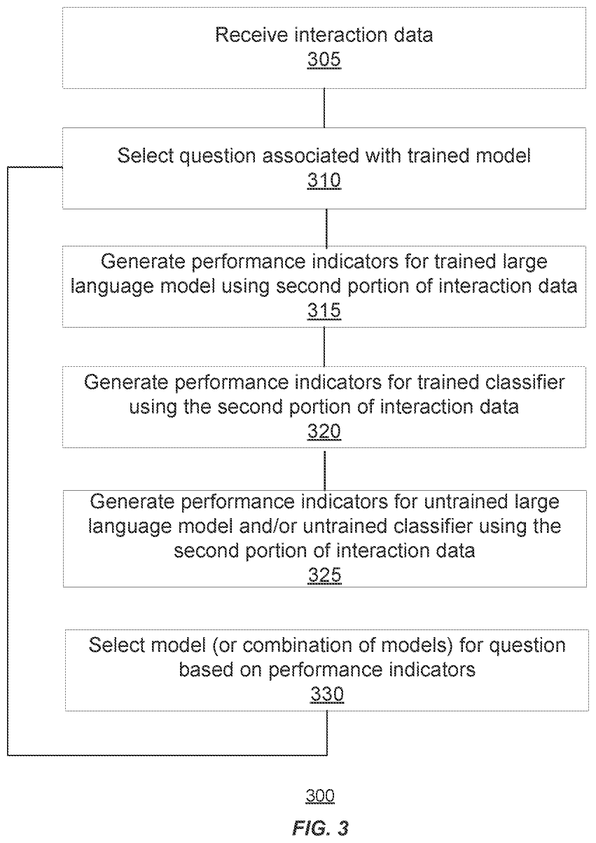

FIG. 3 illustrates an example flow diagram of a method 300 for selecting a model that has the highest performance indicators for a question. The method 300 may be implemented by one or more components of the AQM engine 180.

At block 305, interaction data is received. The interaction data may be historical interaction data 101 and may be received by the performance tester 110 of the AQM engine 180. The interaction data may be the same interaction data received by the AQM engine 180 in the method 200.

At block 310, a question associated with a trained model is selected. The question may be selected by the performance tester 110 from among the questions with models generated by the training component 105.

At block 315, performance indicators for the trained large language model are generated. The performance indicators may be the performance data 112 and may include key performance indicators. The performance data 112 may be generated by the performance tester 110 using the trained LLM 106 and a second portion of the received historical interaction data 101 including the assigned quality metrics 102 for the selected question. Where there are multiple trained LLMs 106, the performance tester 110 may generate performance indicators for each of the trained LLMs 106.

At block 320, performance indicators for the trained classifier are generated. The performance indicators may be the performance data 112 and may include key performance indicators. The performance data 112 may be generated by the performance tester 110 using the trained classifier 107 and the second portion of the received historical interaction data 101 used with the trained LLM 106. Where there are multiple trained classifiers 107, the performance tester 110 may generate performance indicators for each of the trained classifiers 107.

At block 325, performance indicators for the untrained large language model and/or untrained classifier are generated. The performance indicators may be the performance data 112 and may include key performance indicators. The performance data 112 may be generated by the performance tester 110 using the untrained LLM 109 and the second portion of the received historical interaction data 101 used with the trained LLM 106. The performance data 112 may also be generated by the performance tester 110 using the untrained classifier 108 and the second portion of the received historical interaction data 101 used with the trained classifier 107.

At block 330, a model (or combination of models) is selected for the question based on the performance metrics. The model may be selected by the performance tester 110 based on the generated performance data 112 and be one of the trained LLM 106, the trained classifier 107, the untrained LLM 109, or the untrained classifier 108. In some embodiments, if none of the performance metrics of any of the trained LLM 106, the trained classifier 107, the untrained LLM 109, or the untrained classifier 108 exceeds a threshold, the performance tester 110 may determine some combination of the models to user for predictions. Any method for combing models may be used.

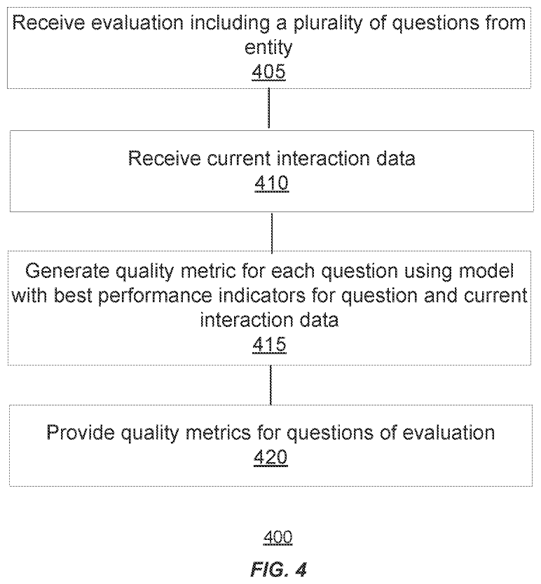

FIG. 4 illustrates an example flow diagram of a method 400 for automatically generating quality metrics for an evaluation using one or more models. The method 400 may be implemented by one or more components of the AQM engine 180.

At block 405, an evaluation including a plurality of questions is received from an entity. The evaluation be received by the quality metric component 115. The entity may be an entity such as a call center and may desire to have a current interaction between an agent and customer evaluated according to the questions associated with the evaluation. The current interaction may be a phone call or a text chat, for example. Other types of entities and interactions may be supported.

At block 410, interaction data for the current interaction is received. The current interaction data 120 may be a transcript or text of the current interaction and may be received by the quality metric component 115. In some embodiments, the QM component 115 may process the current interaction data 120 to move some or all of the metadata into the text of the interactions. For example, the QM component 115 may use a mapping of metadata to text to replace the metadata of the current interaction data 120 with text representations of the metadata.

At block 415, quality metrics for each question are generated. The quality metrics for each question may be generated for each question by the using one or more of the untrained LLM 109, the trained LLM 106, and the trained classifier 107 associated with the question and the current interaction data 120. The QM component 115 may use one or more of the untrained LLM 109, the trained LLM 106, the untrained classifier 108, and the trained classifier 107 for the question based on the performance data 112 generated for each model by the performance tester 110.

At block 420, the generated quality metrics are provided. The generated quality metrics generated for each current question 125 of the evaluation may be provided by the QM component 115 to the entity associated with the evaluation.

FIG. 5 illustrates examples of computers 500 that may include the kinds of software programs, data stores, and hardware that can implement motif determination and forecasting algorithm selection, as described above according to certain embodiments. As shown, the computing system 500 includes, without limitation, a central processing unit (CPU) 505, a graphics processing unit 506, a network interface 515, a memory 520, and storage 530, each connected to a bus 517. The computing system 500 may also include an I/O device interface 510 connecting I/O devices 512 (e.g., keyboard, display and mouse devices) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in the memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of a random access memory. The storage 530 may be a disk drive or flash storage device. Although shown as a single unit, the storage 530 may be a combination of fixed and/or removable storage devices, such as fixed disc drives, removable memory cards, optical storage, network attached storage (NAS), or a storage area-network (SAN). The GPU 506 may be used for training and running models, especially large models such as LLMs.

Illustratively, the memory 520 includes a receiving component 521, a using component 522, a generating component 523, an associating component 524, a mapping component 525, an adding component 526, and training component 527, all of which are discussed in greater detail above. Further, storage 530 includes interaction data 531, evaluation data 532, quality metric data 533, question data 534, classifier data 535, large language model data 536, and transcript data, all of which are also discussed in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for automating quality metrics comprising:
receiving an evaluation including at least one question of a plurality of questions and interaction data representing a current interaction by a computing device;
generating a quality metric for the at least one question for the current interaction using a first large language model or a first classifier and the interaction data representing the current interaction by the computing device; and
associating the quality metric for the at least one question with the current interaction by the computing device.

2. The method of claim 1, further comprising:
receiving interaction data representing previous interactions with one or more agents by the computing device, wherein each interaction is associated with a question of the plurality of questions and a quality metric;
using a first portion of the interaction data representing the previous interactions, training the first large language model or the first classifier by the computing device.

3. The method of claim 2, further comprising:
using a second portion of the interaction data representing the previous interactions, generating performance indicators for the first classifier and the first large language model; and
generating the quality metric for the question for the current interaction using one of the first large language model or the first classifier based on the performance indicators.

4. The method of claim 3, further comprising:
using the second portion of the interaction data, generating performance indicators for a second large language model or a second classifier, wherein the second large language model is not trained using the interaction data and the second classifier is not trained using the first interaction data; and
generating the quality metric for the question for the current interaction using one of the first large language model, the second large language model, the first classifier, or the second classifier based on the performance indicators.

5. The method of claim 4, further comprising:
determining that the generated performance indicators for the first large language model, the second large language model, the first classifier, and the second classifier all fall below a threshold; and
in response to the determination, generating the quality metric for the question for the current interaction using some combination of the first large language model, the second large language model, the first classifier and the second classifier based on the performance indicators.

6. The method of claim 5, wherein the first classifier comprises a neural network classifier, or XGBoost.

7. The method of claim 1, wherein the interaction data for a previous interaction comprises a call transcript and metadata, and further comprising:
mapping the metadata to text; and
combining the text with the call transcript.

8. A system for automating quality metrics comprising:
a computing device; and
a computer-readable medium with computer-executable instructions stored thereon that when executed by the computing device cause the computing device to:
receive an evaluation including at least one question of a plurality of questions and interaction data representing a current interaction;
generate a quality metric for the at least one question for the current interaction using a first large language mode or a first classifier and the interaction data representing the current interaction; and
associate the quality metric for the at least one question with the current interaction.

9. The system of claim 8, further comprising computer-executable instructions that when executed by the computing device cause the computing device to:
receive interaction data representing previous interactions with one or more agents by the computing device, wherein each interaction is associated with a question of the plurality of questions and a quality metric;
use a first portion of the interaction data representing the previous interactions, training the first large language model or the first classifier.

10. The system of claim 9, further comprising computer-executable instructions that when executed by the computing device cause the computing device to:
using a second portion of the interaction data representing the previous interactions, generate performance indicators for the first classifier and the first large language model; and
generate the quality metric for the question for the current interaction using one of the first large language model or the first classifier based on the performance indicators.

11. The system of claim 10, further comprising computer-executable instructions that when executed by the computing device cause the computing device to:
use the second portion of the interaction data, generating performance indicators for a second large language model or a second classifier, wherein the second large language model is not trained using the interaction data and the second classifier is not trained using the first interaction data; and
generate the quality metric for the question for the current interaction using one of the first large language model, the second large language model, the first classifier, or the second classifier based on the performance indicators.

12. The system of claim 11, further comprising computer-executable instructions that when executed by the computing device cause the computing device to:
determine that the generated performance indicators for the first large language model, the second large language model, the first classifier, and the second classifier all fall below a threshold; and
in response to the determination, generate the quality metric for the question for the current interaction using some combination of the first large language model, the second large language model, the first classifier, and the second classifier based on the performance indicators.

13. The system of claim 12, wherein the first classifier comprises a neural network classifier, or XGBoost.

14. The system of claim 8, wherein the interaction data for a previous interaction comprises a call transcript and metadata, and further comprising computer-executable instructions that when executed by the computing device cause the computing device to:
map the metadata to text; and
combine the text with the call transcript.

15. A non-transitory computer-readable medium with computer-executable instructions stored thereon that when executed by a computing device cause the computing device to:
receive an evaluation including at least one question of a plurality of questions and interaction data representing a current interaction;
generate a quality metric for the at least one question for the current interaction using a first large language model or a first classifier and the interaction data representing the current interaction; and
associate the quality metric for the at least one question with the current interaction.

16. The computer-readable medium of claim 15, further comprising computer-executable instructions that when executed by the computing device cause the computing device to:
receive interaction data representing previous interactions with one or more agents by the computing device, wherein each interaction is associated with a question of the plurality of questions and a quality metric;
use a first portion of the interaction data representing the previous interactions, training the first large language model or the first classifier.

17. The computer-readable medium of claim 16, further comprising computer-executable instructions that when executed by the computing device cause the computing device to:
using a second portion of the interaction data representing the previous interactions, generate performance indicators for the first classifier and the first large language model; and
generate the quality metric for the question for the current interaction using one of the first large language model or the first classifier based on the performance indicators.

18. The computer-readable medium of claim 17, further comprising computer-executable instructions that when executed by the computing device cause the computing device to:
use the second portion of the interaction data, generating performance indicators for a second large language model or a second classifier, wherein the second large language model is not trained using the interaction data and the second classifier is not trained using the first interaction data; and
generate the quality metric for the question for the current interaction using one of the first large language model, the second large language model, the first classifier, or the second classifier based on the performance indicators.

19. The computer-readable medium of claim 18, further comprising computer-executable instructions that when executed by the computing device cause the computing device to:
determine that the generated performance indicators for the first large language model, the second large language model, the first classifier, and the second classifier all fall below a threshold; and
in response to the determination, generate the quality metric for the question for the current interaction using some combination of the first large language model, the first classifier, the second large language model, and the second classifier based on the performance indicators.

20. The computer-readable medium of claim 15, wherein the interaction data for a previous interaction comprises a call transcript and metadata, and further comprising computer-executable instructions that when executed by the computing device cause the computing device to:
map the metadata to text; and
combine the text with the call transcript.
